(19) United States
(12) Patent Application Publication
(10) Pub. No.: US 2004/0089219 A1
(43) Pub. Date: May 13, 2004

(54) Indicating device with a pointer and a light source

(76) Inventors: Alf Burau, Aschaffenburg (DE); Heinrich Noll, Gross-Umstadt (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/451,750

(22) PCT Filed: Dec. 17, 2001
(86) PCT No.: PCT/DE01/04727

(30) Foreign Application Priority Data
Dec. 22, 2000 (DE) 100 64 766.9
May 31, 2001 (DE) 101 26 712.6

(51) Int. Cl. G01D 11/28

(52) U.S. Cl. 116/288

(57) ABSTRACT

The invention relates to an indicating instrument (1) which comprises a pointer, situated in front of a dial (2). Light is coupled into the axis (5) of the pointer. The light is guided into the pointer vane (3) by a deviating prism (8). The invention provides that in order to prevent a visible halo from appearing on the dial (2), around the axis (5), the light that is coupled into said axis (5) is UV light which is only converted into visible light in the pointer vane (3), by the luminescent material (10) that is present there.

The invention relates to an indicating device, in particular for a motor vehicle, having a pointer in front of a dial and a light source whose light is coupled into the pointer vane of the pointer.

Indicating devices of this type are primarily used in automobile construction. These have to be designed in such a way that information relevant to the driver is displayed clearly and distinctly even in darkness. This is achieved, for example, by the pointer of a speed indicator being coupled to a light source in such a way that said pointer stands out luminously in front of the dark dial provided with luminous numbers.

In the case of the previous designs, some of the light emitted by the light source does not get into the pointer vane but is coupled out previously as scattered light, so that a halo is formed on the dial around the shaft of the pointer. This reduces the contrast of the indicator, so that many efforts have been made to suppress the halo.

The present invention is therefore based on the problem of providing an indicating device of the aforementioned type in which no disruptive brightening of the dial occurs.

To this end, the invention proposes that the spectrum of the light lies in the non-visible range and, in the pointer vane, there are means which effect conversion into the visible range.

Although here, too, some of the light coupled into the pointer or into the shaft at the pointer emerges again as scattered light and is deflected toward the dial, the light reflected there is not perceived by the driver, since it lies in the non-visible range. The light which is detected by the driver as the pointer vane lighting up is only produced in the pointer vane by the conversion means.

In the simplest case, an LED which emits ultraviolet light is used as the light source. On account of the LED, the indicating device is particularly long-lasting and energy-saving.

The conversion means used is a luminescent material which reacts to this light and, because of the excitation by UV light, in turn emits light in the visible range. The material can be, for example, a fluorescent or phosphorescent material. In the case of a phosphorescent material there is also the advantage that the pointer vane will continue to light up, which may be of interest for specific applications, for example in the case of a clock.

In the simplest case, the material is applied as a layer to the underside of the pointer vane. The UV light streams in from the foot of the pointer vane and, because of the flat angle of incidence, as a result of complete reflection at the upper side of the pointer vane, is led to the underside. There, it strikes the luminescent material, which then emits visible light toward the other side of the pointer vane.

In this case, the angle of incidence is so great that the light emerges from the upper side and becomes perceptible by the observer.

Alternatively to this, the material can also be applied to the upper side of the pointer vane. In this case, however, it must be transparent to visible light. In addition, there should be a reflective layer on the underside, which reflects the light arriving from the upper side back there.

Aesthetically particularly pleasing pointers are obtained if a plastic material is chosen which is dark but which is translucent to UV light. A pointer of this type is provided with the luminescent material on the upper side.

The material can be applied to the pointer or introduced into the material of the pointer vane as doping. The possible risk that the material adhering to the surface of the pointer vane detaches again is therefore not present.

Thought can also be given to producing the pointer vane from a material which is continuously doped with the luminescent material.

The light is normally coupled into the pointer vane coming from the shaft of the pointer. In the procedure according to the invention, however, the pointer vane can also be formed as a segment of a translucent disk, the UV light being coupled into the edge of the disk. For the observer, however, only the regions provided with the luminescent material are visible as a pointer vane.

Should the light be coupled into the shaft of the pointer and passed on from there into the pointer vane, it is suggested to form the shaft from a metal tube, at whose inner walls the light is reflected. This dispenses with the necessity to produce the shaft from UV-light-resistant plastic material.

The clarity and therefore also the legibility of the indicating device is advantageously improved if the means effecting conversion of the light into the visible range are present in a first subarea of the pointer vane, and if there are no such means in a second subarea of the pointer vane adjacent to the first subarea. As a result, the region of the pointer vane which is important for reading can be emphasized in such a way that only this region lights up. In this case, this is preferably the pointer tip.

A further improvement in the legibility can advantageously be achieved by there being, in different regions in the pointer vane, different means which effect conversion of the light in respectively different colored visible ranges. In the event of such a use of different means, configuration of multicolored pointers is possible, for example the pointer vane can have a red tip and a yellow body, without different colored light sources having to be used.

The invention permits various embodiments. In order to illustrate its basic principle further, three of these are illustrated in the drawing and will be described below. In the drawing:

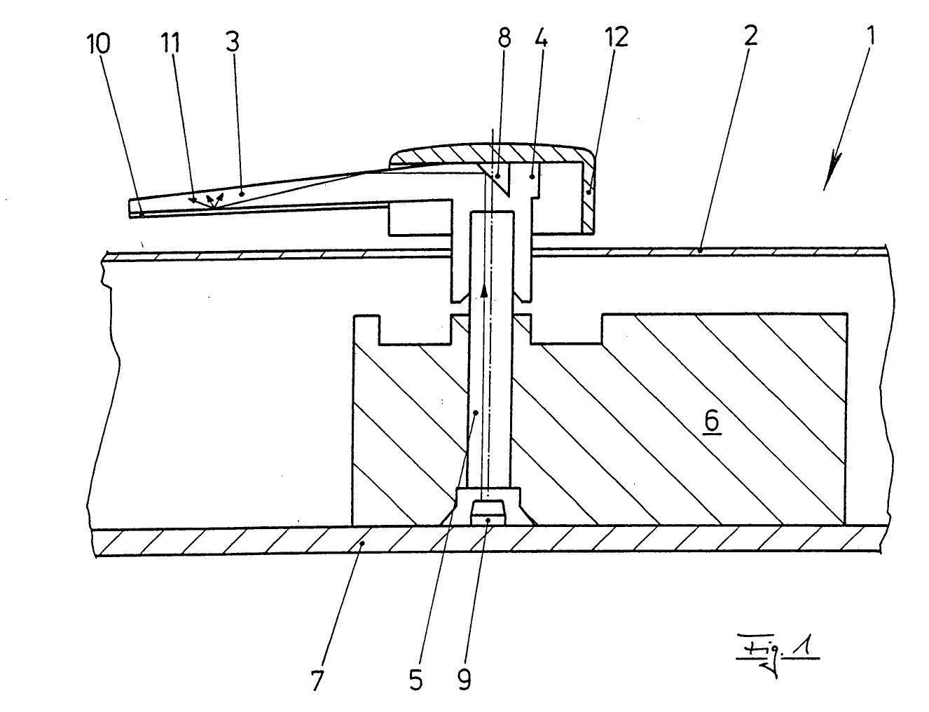

FIG. 1 shows a first indicating device with a pointer,

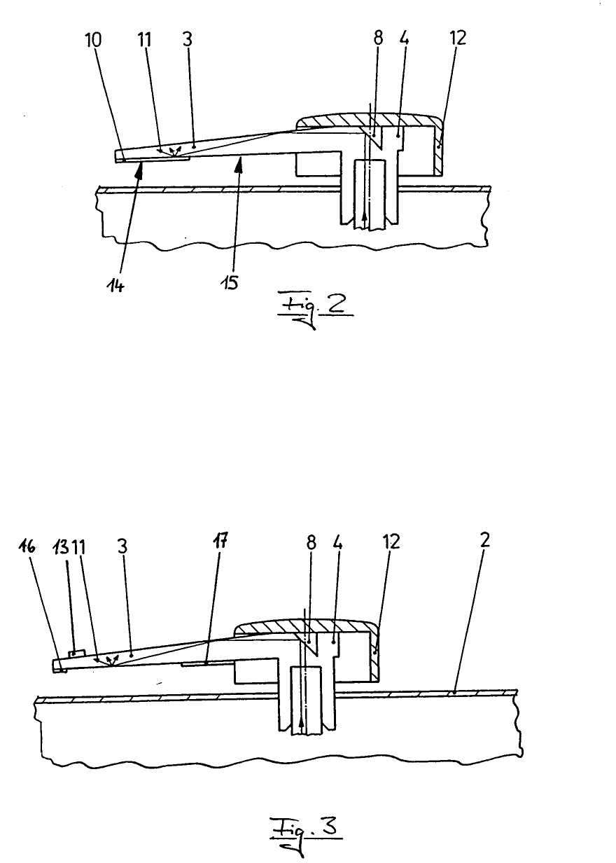

FIG. 2 shows a pointer of a second indicating device and

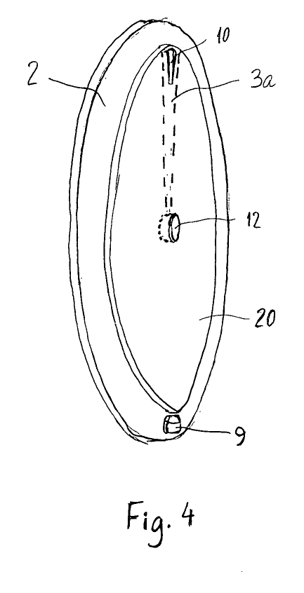

FIG. 3 shows a pointer of a further indicating device.

According to FIG. 1, an indicating device 1 comprises a dial 2 with a pointer, whose pointer vane 3 lies in front of the dial 2. The head 4 of the pointer vane 3 is coupled to a shaft 5. Underneath the dial 2 there is a drive unit 6 on a printed circuit board 7. By means of the drive unit 6, the pointer is set to the desired position by rotating the shaft 5. For this purpose, a worm gear mechanism not illustrated here is normally arranged between the shaft 5 and the drive unit 6.

The shaft 5, the head 4 of the pointer and the pointer vane 3 consist of light-conducting plastic and, in this sense, function as light conductors. At the lower end, an LED 9 is arranged out of the printed circuit board 7 and couples UV light into the lower end of the shaft 5. This light streams into the head 4 of the pointer and there is led into the pointer vane 3 by what is known as a deflection prism 8. In the process, it is impossible to avoid some of the light emerging downward from the head 4 and striking the dial 2 in an area around the shaft 5. In the event that visible light were used, it would be possible to make out what is known as a halo. However, because of the fact that light in the non-visible range is used, this remains invisible to the observer.

The light led into the pointer vane 3, following total reflection at the upper side of the pointer vane 3, strikes the underside which, in this exemplary embodiment, is coated with an outer layer 10 of luminescent material.

As a result of the incidence of the UV light, the atoms and molecules in the layer 10 are excited and in turn emit light in the visible range which, as indicated by the arrows 11, is sent out upward. This procedure takes place over the entire length of the pointer vane 3, so that the latter appears to the observer of the indicating instrument as a luminous structure.

In order to limit the visible light sharply to the pointer vane 3, a cap 12 is placed on the head 4 of the pointer and covers this area.

As already explained further above, the layer 10 can be introduced into the material of the pointer vane 3 as doping. Thought can also be given to doping the entire pointer vane. In this case, however, it is recommended to apply a reflective layer to the underside of the pointer vane 3.

In all the figures, identical elements are provided with identical reference symbols.

FIG. 2 shows a pointer which differs from that according to FIG. 1 in that there are means effecting conversion of the light into the visible range in a first subarea 14 of the pointer vane, comprising the pointer tip, but not in a second subarea 15 of the pointer vane 3.

This second subarea 15 of the pointer vane 3 is an area of the pointer vane 3 facing the cap 12. In the case of a pointer according to FIG. 2, only the pointer tip stands out luminously.

A further pointer is shown in FIG. 3, a pointer vane 3 having different means 13, 16, 17 which effect conversion of the light into respectively different colored visible ranges in different areas. One means 16 is arranged on the underside of the pointer vane 3 in the area of the pointer tip, a further means 17 is likewise arranged 6n the underside of the pointer vane 3 but in an area of the pointer vane 3 that faces a cap 12, and a further means 13 is located as a translucent layer on the upper side of the pointer vane 3, in an area in which no corresponding means are arranged on the underside of the pointer vane 3. Thus, the pointer tip can light up in a different color than that of the area of the pointer vane 3 that faces the cap 12, and a central area of the pointer vane 3 can have a further, third color.

1. An indicating device, in particular for a motor vehicle, having a pointer and a light source whose light is coupled into the pointer vane of the pointer, characterized in that the spectrum of the light lies in the non-visible range and, in the pointer vane (3), there are means (10) which effect conversion into the visible range.

2. The indicating device as claimed in claim 1, characterized in that the light from the light source (9) is UV light.

3. The indicating device as claimed in claim 2, characterized in that the light source (9) is an LED emitting UV light.

4. The indicating device as claimed in one of the preceding claims, characterized in that the conversion means (10) consist of luminescent material.

5. The indicating device as claimed in claim 4, characterized in that the luminescent material is located as a layer (10) on the underside of the pointer vane.

6. The indicating device as claimed in claim 4, characterized in that the luminescent material is located as a translucent layer (13) on the upper side of the pointer vane (3).

7. The indicating device as claimed in claim 4, characterized in that the pointer (3) consists of a material that is dark but translucent to UV light.

8. The indicating device as claimed in claim 5 or 6, characterized in that the luminescent material is introduced into the material of the pointer vane (3).

9. The indicating device as claimed in one of the preceding claims, characterized in that the pointer vane (3) is constituted as part of a transparent disk, in that the light is coupled in from the edge of the disk, and in that a segment-like portion of the disk is provided with the conversion means.

10. The indicating device as claimed in one of claims 1 to 8, characterized in that the pointer vane (3) is fixed at one end of a shaft (5), in that the light is coupled into the other end of the shaft (5) and in that the shaft (5) consists of a metal tube at whose inner walls the light is reflected.

11. The indicating device as claimed in one of the preceding claims, characterized in that there are means (10) effecting conversion of the light into the visible range in a first subarea (14) of the pointer vane (3), and in that there are no such means in a second subarea (15) of the pointer vane (3) adjacent to the first subarea.

12. The indicating device as claimed in one of the preceding claims, characterized in that in different areas in the pointer vane (3) there are different means (13, 16, 17) which effect conversion of the light into respectively different colored visible ranges.
